(19) United States
(12) Patent Application Publication
(10) Pub. No.: US 2008/0100930 A1
(43) Pub. Date: May 1, 2008

(54) Optical measuring system, and a projection objective

(75) Inventors: Hubert Holderer, Oberkochen (DE); Werner Lang, Geislingen (DE); Alexander Kohl, Aalen (DE); Bernhard Gellrich, Aalen (DE); Hartmut Brandenburg, Westhausen (DE); Johannes Rau, Gerstettem (DE); Armin Schoeppach, Aalen (DE)

Correspondence Address: WELSH & KATZ, LTD, 120 S RIVERSIDE PLAZA, 22ND FLOOR, CHICAGO, IL, 60606, US

(73) Assignee: Carl Zeiss SMT AG, Oberkochen (DE)

(21) Appl. No.: 12/002,694

(22) Filed: Dec. 17, 2007

Related U.S. Application Data
(63) Continuation of application No. 10/757,189, filed on Jan. 14, 2004, now abandoned.

(30) Foreign Application Priority Data
Jul. 20, 2002 (EP) PCT/EP02/08611
Jul. 26, 2001 (DE) DE 10136 388.5

(51) Int. Cl. G02B 17/00; G02B 7/02

(52) U.S. Cl. 359/726; 359/811

(57) ABSTRACT

An optical measuring system is provided with a measuring machine that has at least one measuring element for determining locations and at least one measuring element for determining angles. At least one common reference surface is provided for the location-determining measuring element and the angle-determining measuring element.

The invention relates to an optical measuring system and a projection objective for imaging an object from a first plane into a second plane.

Particularly in the case of the assembly of the objective, for example in semiconductor lithography, objective parts must be set up relative to one another with a high absolute accuracy both in the spatial coordinates and in the angular coordinates.

Known for this purpose are measuring units or measuring machines with a measuring table and a measuring head which, for example, have tactile probes. These measuring units are designed, for example, as battery or stator measuring machines and can undertake absolute determination of locations with reference to a freely selectable reference point with high accuracy. However, it is a problem when, in addition to exact determination of location, there is also a need to keep accurate angular positions as well. A further difficulty occurs when a plurality of optical axes are present in the case of an objective, as happens, for example with an objective of the H design. Objectives of this type are assembled from a plurality of subgroups which each have an “lower axis” as optical axis, it being necessary for individual axes to be set with very high accuracy at a specific spacing from one another both as regards angle and with reference to the center of the individual subgroups. The individual optical axes must be assigned very accurately, in particular.

Reference may be made to U.S. Pat. No. 6,195,213 B1 as regards the general prior art.

EP 1 168 028 A2 discloses a projection system that has an optical system with at least one refractive element and a multiplicity of reflective elements. A multiplicity of flange mounts hold the optical system, which is divided into a multiplicity of individual systems. The multiplicity of the reflective elements is mounted in only one flange mount. This overall system is therefore assembled to form an overall structure from individual modules/individual units. Each individual unit is adjustable per se. It is a disadvantage of such a modular design of the projection system that the flange mounts, which assume the function of carrier structure for the overall projection system, require a metallic material that, in turn, gives rise to a poor mechanical and thermal long term stability and a large mass.

As regards the prior art, reference is made here, again, to U.S. Pat. No. 6,195,213 B1, which discloses, in turn, a modular design for the projection objective as in EP 1 168 028 A2. The modular design of the flange mounts is thereby expanded by an additional structure to which the modularly designed objective tubes are screwed.

U.S. Pat. No. 6,529,264 B1 discloses a projection objective with a design similar to that disclosed in U.S. Pat. No. 6,195,213 B1 and which has a first optical system that is arranged between a reticle and first reflective optical element. A second optical system is arranged between the first reflective element and a substrate, in particular a wafer. The first optical system is held by a first objective tube, and the second optical system is held by a second objective tube. A frame structure or a transverse beam connects the first objective tube to the second objective tube. The objective tubes are further supported one against the other by means of such a design. It is a disadvantage of such a construction of the projection objective that, owing to the transverse connection, the two objective tubes each have the same vibrational frequency.

U.S. Pat. No. 6,473,245 B1 discloses the development of the projection objective known from U.S. Pat. No. 6,529,264 B1. The previously existing structure is expanded to form a support structure with two platforms on which the objective tubes are suspended. The objective tubes are supported in two planes by flexible elements that are each arranged opposite one another at the edge of openings in the platforms into which the objective tubes are inserted. The flexible elements permit objective tubes to be moved radially at right angles to their optical axis and permit a linear movement of the objective tubes along the optical axis, and are stiff relative to a rotation about their optical axes. The optical axes of the two disclosed objective tubes are arranged parallel to one another. An objective tube of H design for beam guidance that is arranged transverse to the optical axes of the objective tubes interconnects the two vertical objective tubes which are parallel to one another.

A projection objective of such construction has the disadvantage of a relatively complicated design intended to provide temperature compensation and vibration compensation.

The object of the present invention is to create an optical measuring system for measuring components in the case of which a component assembled from a plurality of parts and/or subgroups is set up very accurately with regard to the determination of location and angle.

It is likewise the object of the present invention to create a projection objective in which optical elements and optical modules are mounted exactly and at a stable position with regard to determination of location and angle.

This first object is achieved according to the invention by means of the features of claim 1.

One of the core points of the solution according to the invention consists in that there is not, as before, either a tactile measuring system or optical measuring system provided for the purpose of measuring geometrical values, thus lengths and angles, that is to say positions and orientations, but according to the invention two independent measuring systems are present that both act independently of one another, but access a common measuring reference.

However, there is also the possibility, as an alternative, of forming two different measuring references, and then combining the two partial references to form a common computational overall reference. In other words, there are two zero positions to hand which are then mutually calibrated in order to form a computational overall reference therefrom. This can be performed, for example, by two probes that operate independently of one another and respectively derive their coordinates from a sphere.

This results overall in a reference with 6° of freedom and a coordinate system in x, y and z directions and having three solid angles.

Components can be measured exactly with regard to determining both location and angle and then be mounted appropriately because of the inventive combination of a measuring unit for exact determination of location with an optical measuring system, for example an autocollimation telescope or an interferometer, the two measuring systems having the same reference plane, that is to say being referred to the same reference.

It is thereby rendered possible, in particular, to use two measuring systems simultaneously, successively or else alternately, specifically without the need to change the position of the component to be measured.

The two measuring methods complement one another in an optimum association since, for example, the measuring element with a tactile probe predominantly measures length, flatness and shapes, whereas the optical measuring system measures chiefly angles and angular positions. Known measuring machines can be used for the mechanical measuring system with the measuring element and tactile probe. Since the optical measuring system is substantially more accurate than the tactile measuring system, the overall measuring system is thereby able to operate more accurately. Angular positions can be determined accurately to 0.05 seconds of angle. The tactile measuring accuracies can be gathered from the appropriate machine data.

According to the invention, the second object is achieved by means of the features of claim 20.

According to the invention, a projection objective is provided that has at least two lens barrels, refractive and reflective optical elements, a basic structure for bearing and holding the optical elements and at least two lens barrels and interface elements, via which the lens barrels are advantageously connected to the basic structure. The interface effect between the basic structure and the lens barrels is based here not on a malleability of flexures, which are of only very limited stiffness in the non enabled degrees of freedom, but on suitable material pairing and mechanical configuration in the interface element. The stiffness of the connection between the lens barrels and basic structure is substantially greater owing to the interface elements than would be the case when using flexures between the lens barrels and the basic structure. The vibrational effects from the overall projection objective can thus be substantially minimized.

Advantageous developments and refinements may be seen from the remaining subclaims.

An exemplary embodiment of the invention is described below in principle with the aid of the drawing, in which:

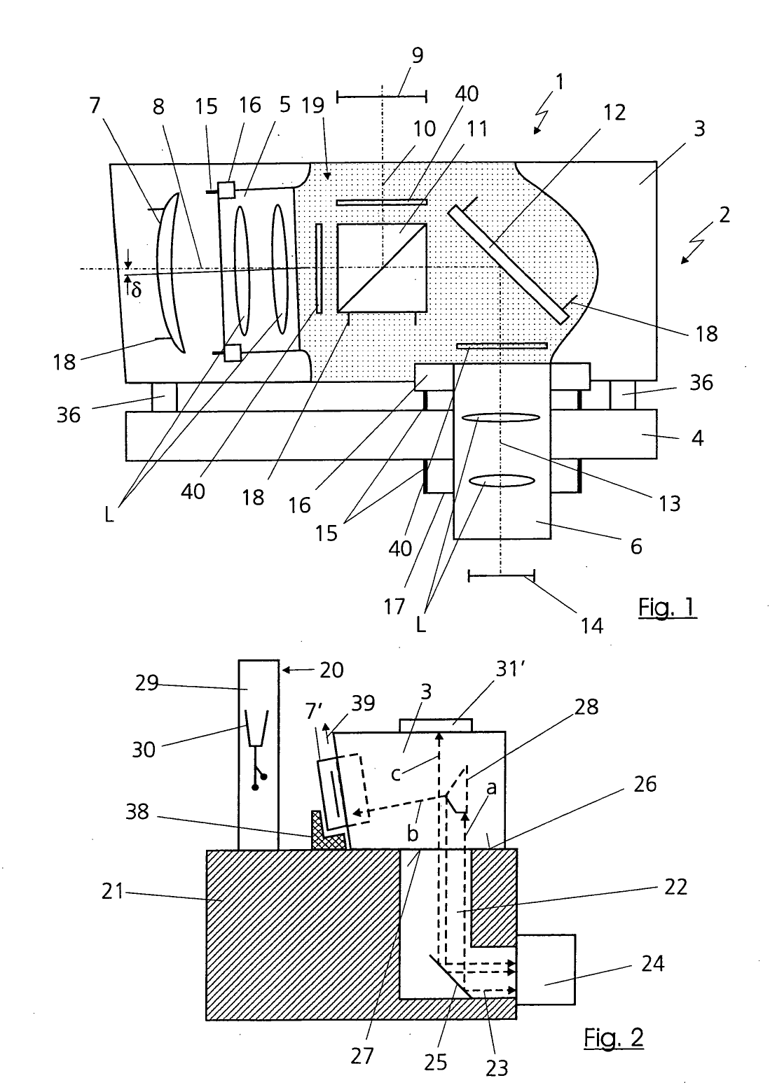

FIG. 1 shows an illustration of the principle of a projection objective according to the invention;
jection objective;

FIG. 2 shows an illustration of the principle of the measuring machine according to the invention;

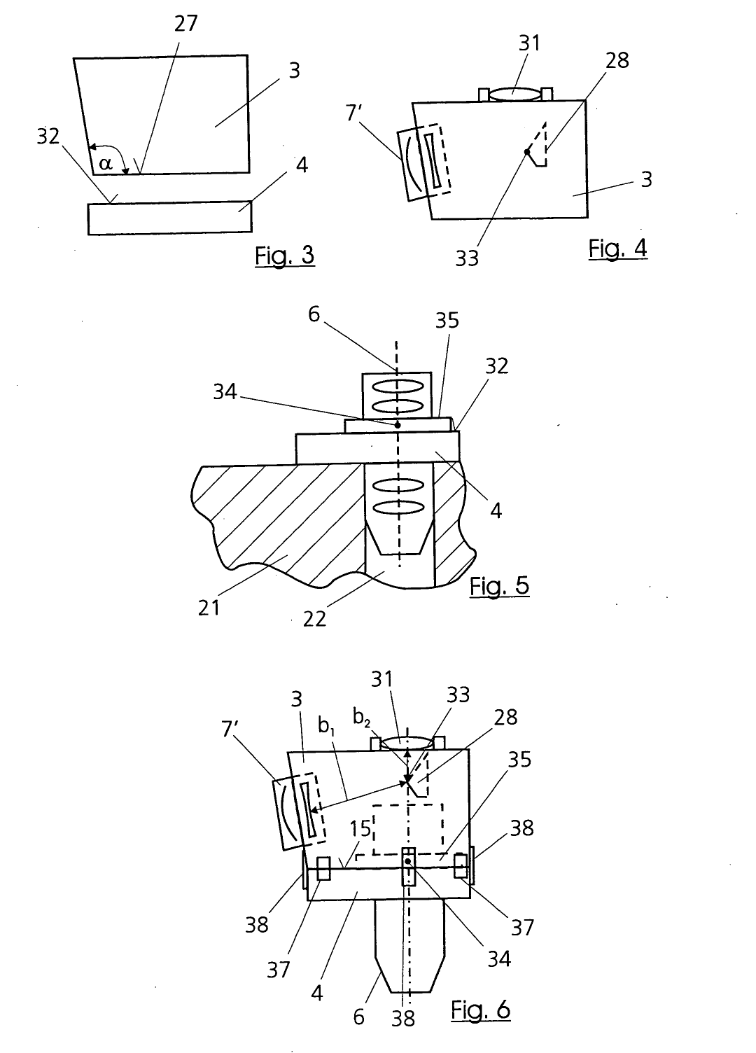

FIG. 3 shows two frame structures for an objective of H design;

FIG. 4 shows the upper part of the frame structure according to FIG. 3 after installation of a double mirror, a mirror group and lenses;

FIG. 5 shows the lower part of the frame structure according to FIG. 3, after installation of the refractive part of an objective; and

FIG. 6 shows the assembly of the upper part and the lower part of the objective.

Illustrated in principle in FIG. 1 is a projection objective 1 that is designed as a catadioptric projection objective. The projection objective 1 has a basic structure 2 that is subdivided into two frame structures, specifically into an upper frame structure 3 and a lower frame structure 4, and this provides the advantage that optical elements and/or modules can be adjusted very accurately relative to one another. It is possible to make use for the bipartite basic structure 2 of materials that fulfill the essential requirements such as weight limitation, dynamic and thermoelastic stability, substantially better than the materials previously used. These are, for example nonmetallic inorganic materials such as ceramic, preferably silicon carbide (SiC), in particular reaction-bonded silicon-infiltrated silicon carbide (SiSiC) or sintered silicon carbide (SSiC). SiSiC is a composite material made from a porous basic body of silicon carbide that is infiltrated liquid Si metal at high temperature. SSiC is produced from SiC powder mixed with sinter additives, the mixture being produced with the aid of a with the aid of a dry press method, normally used in ceramics normally used in ceramics, and sintering at a temperature of above 2000° C. to form SSiC. The advantages of such materials consist in good thermal conductivity, very good processability, and in cost effective procurement. Furthermore, the materials are SiSiC and SSiC materials that have material properties which are stable and/or not dependent on production, and are, moreover, available worldwide.

The projection objective 1 has at least two lens barrels 5 and 6, one lens barrel 5 being supported in the upper frame structure 3, and having an approximately horizontal optical axis. A second lens barrel 6 has a vertical optical axis and is supported in the lower frame structure 4. The lens barrels 5 and 6 each have at least one refractive optical element L. Provided downstream of the lens barrel 5 in the beam direction in the upper frame structure 3 is a reflective element 7 that is designed as a concave mirror, and therefore reflects a projection beam path to a beam splitter element 11. The lens barrel 5 and the concave mirror 7 are arranged at an angle δ to a horizontal optical axis 8 in the upper frame structure 3. The angle δ has a value in a range from 10° to 15°.

The beam splitter element 11 is provided in order to deflect the projection beam path (not illustrated) which enters the upper frame structure 3 from a reticle 9, from a vertical optical axis 10 into the horizontal optical axis 8. After reflection of the projection beam path at the concave mirror 7 and subsequent passage through the beam splitter element 11, this strikes the deflecting mirror 12. At the deflecting mirror 12, the horizontal projection beam path is deflected into a vertical projection beam path along a vertical optical axis 13. Thereafter, the projection beam path passes through the lens barrel 6 and strikes a substrate 14 that is preferably designed as a wafer.

strate 14.

Located additionally in the beam path are λ/4 plates 40, a first λ/4 plate being arranged between the reticle 9 and the beam splitter element 11, and thereby rotating the polarization direction of the projection beam path by 90°. A further λ/4 plate is arranged along the horizontal optical axis 8, and a third λ/4 plate is arranged along the vertical optical axis 13. The polarization direction is in each case rotated or changed by an arrangement of the λ/4 plate in the projection objective 1 in order, inter alia, to minimize beam losses.

In order to support and hold the lens barrels 5 and 6 on the basic structure 2 interface elements 15 are provided which are designed to be stiff in all degrees of freedom. Each of the lens barrels 5 and 6 has only one interface element 15, which is designed as a thin-walled closed tubular element. When a force or a torque is applied to the interface elements 15, the latter prevent movement, and thus a movement of the lens barrels 5 and 6 inside the projection objective 1. Despite being stiff in all degrees of freedom, the interface elements 15 ensure thermal differential expansion or a thermoelastic compensation between the basic structure 2 and the lens barrels 5 and 6 in conjunction with possible differences in coefficients of expansion of the basic structure 2 and the lens barrels 5 and 6. Such a thermal expansion compensation can be undertaken by use and/or combination of the specific materials such as, for example, invar, ceramic and steel, in the interface element 15. The lens barrels 5 and 6 can thus be held or supported in the basic structure 2 in a fashion that is very stiff or virtually free of rotation. The interface elements 15 are connected via flanges 16 to the respective lens barrel 5 or 6.

Because of its large length, the lens barrel 6 is held, in addition to the interface element 15, by a flexible element 17 that is designed as a diaphragm and is soft in an axial direction, in a second plane. The flexible element 17 holds the lens barrel 6 in position radially, without being positively guided axially. The additional flexible element 17 should be formed from a material that has approximately the same coefficient of thermal expansion as that of the lens barrel 6.

The reflective elements, specifically the concave mirror 7 and the deflecting mirror 12, are held in the upper frame structure 3 via bearing elements 18, preferably via an isostatic bearing. The beam splitter element 11 is also held in the upper frame structure 3 via the bearing element 18, here preferably also via an isostatic bearing. An isostatic bearing is understood as a bearing where only in each case 2 degrees of freedom are fixed at 3 bearing points.

The lens barrels 5 and 6 have no direct connecting surfaces with the basic structure 2, but are supported in each case on the basic structure 2 via the interface element 15.

By selecting as material SiSiC or SSiC (both ceramics), which are not porous and have a very dense structure, the basic structure 2 is designed in such a way that it can take over a sealing function for the projection objective 1 at desired points of the basic structure 2. The lens barrels 5 and 6 in each case form a closed unit and preferably themselves take over the sealing function for their optical parts arranged in the interior. This means that the material of the basic structure 2, specifically the ceramic, does not come into contact in the regions of the lens barrels 5 and 6 with a purge gas which is provided inside the lens barrels 5 and 6 in order to avoid instances of contamination on optical surfaces of the refractive elements L.

A region 19 in the interior of the projection objective 1 that is, for example, bounded on one side by the lens barrel 5, and on the other side by the lens barrel 6, has the beam splitter element 11 and the deflecting mirror 12. In the region 19, the upper frame structure 3 of the basic structure 2 itself takes over the sealing function. In the region of the concave mirror 7, an additional sheath (not illustrated here) that surrounds the region of lens barrel 5 up to the concave mirror 7 can take over the sealing function. Consequently, the purge gas is used to purge inside the lens barrels 5 and 6, in the region 19 and in the region of the lens barrel 5 and the concave mirror 7, in order to avoid instances of contamination on the optical surfaces. However, it would also be possible for the basic structure 2 not to take over any sealing function in the region 19, the region 19 then being separated from the upper frame structure 3 so that no purge gas can penetrate to the surfaces of the basic structure 2. Should the basic structure 2 not take over any sealing function, it need not fulfill any extreme requirements with reference to contamination and tightness.

A projection objective 1 constructed in such a way is constructed, as described below, from the individual optical components and/or optical modules 2, 5, 6, 7, 11 and 12, and the optical elements and/or modules 2, 5, 6, 7, 11 and 12 are positioned exactly relative to one another.

Illustrated in FIG. 2 is a measuring machine that essentially has a gantry measuring machine 20 of known design.

It has a measuring table 21 as a granite block that has a vertical measuring bore 22 with a transverse bore 23 in the lower region. An autocollimation telescope 24 or an interferometer is flanged on at the end of the transverse bore 23. A deflecting mirror 25 is arranged at the point where the measuring bore 22 meets the transverse bore 23. The autocollimation telescope 24 (or the interferometer) can be calibrated to the surface of the measuring table 21 as reference surface 26 with the aid of the deflecting mirror 25 and an additional plane mirror (not illustrated) that can be laid on the surface of the measuring table 21 over the measuring bore 22. It is possible in this way for surfaces that are to be measured with the aid of the autocollimation telescope 24 always to be referenced in absolute terms as if to the measuring surface 26. It is a pre-condition for this that the flatness of the granite surface of the measuring table 21 is adapted to the required accuracy.

The imaging is carried out in conjunction with an optical measuring head, for example a CCD camera, by means of the autocollimation telescope 24 or an interferometer. It is also possible to use an optical sensor, if appropriate, instead of an optical measuring head.

As may be seen from FIG. 3, the assembled projection objective 1 is inserted into the upper frame structure 3 and the lower frame structure 4.

The upper frame structure 3 is mounted on the measuring table 21 in a first step in order to assemble and/or install the optical parts of the projection objective 1. The underside of the upper frame structure 3 likewise serves as reference surface 27 with the same requirements placed on the flatness as those placed on the reference surface 26 of the measuring table 21. For the purpose of simplifying the mode of procedure, instead of the beam splitter element 11 and the deflecting mirror 12 in accordance with FIG. 1, a double mirror (mirrors arranged at an angle to one another) or a prism 28 is inserted into the upper frame structure 3, and a plane mirror 7′ is simultaneously flanged on at the side. Subsequently, the underside of the double mirror 28 is aligned as auxiliary by means of the autocollimation telescope 24 (or an interferometer) (see the beam path a in FIG. 2 in this regard). The auxiliary surface is produced during optical fabrication with an appropriate angular accuracy relative to the front surfaces. The double mirror 28 is aligned in this way with appropriate accuracy within the horizontal plane.

Subsequently, the plane mirror 7′ and the double mirror 28 are aligned with the aid of the autocollimation telescope 24 (see beam path b). It is to be borne in mind here that an optical beam emanating from the autocollimation telescope 24 is retroreflected by the plane mirror 7′. In this way, the optically active surfaces of the double mirror 28 are aligned relative to the reference surface 26 and the flanging-on surface and, in addition, the flanging-on surface of the plane mirror 7′ is also aligned with appropriate accuracy.

A measuring head 29 of the gantry measuring machine 20 is now used in order to control the distance of the tip of the double mirror 28 from the plane mirror 7′. It is known for this purpose to use a tactile measuring element 30 of the measuring head 29. In order to measure with the aid of the measuring element 30, the measuring head 29 is displaced accordingly on the surface of the measuring table 21. If the distance is wrong, it is corrected, the preceding points being appropriately repeated. In addition, the distance of the double mirror 28 from the reference surface 26 is monitored, and likewise changed if required, the points named above likewise being repeated.

Subsequently, a plane mirror 31′ is mounted on the upper frame structure 3. The plane mirror 31′ is aligned in angular terms with the reference surface 26 with the aid of the autocollimation telescope 24 (or an interferometer) (see beam path c). During assembly of the projection objective 1, the plane mirror 31′ can be replaced by a lens or lens group 31. Finally, the measuring head 29 is used to monitor once again the distance of the plane mirror 31′ from the tip of the double mirror 28. If the distance is wrong, it is corrected, the last mentioned steps being repeated.

After these measuring steps, the parts inside the upper frame structure 3, in particular the plane mirror 7′, which can, of course, also be replaced later by the concave mirror 7 and the lens barrel 5, are aligned, in terms of the positions, with the tip of the double mirror 28 and, in terms of the angles, with the reference surface 26, in an absolute fashion in accordance with the accuracy. At the same time, the height of the double mirror 28 is also set, in an absolute fashion, relative to the reference surface 26. Evidently, at the same time, the parts of the component to be measured, specifically in this case the upper frame structure 3 of the projection objective 1 can be simultaneously measured and/or set up on one and the same measuring machine 20 with the aid of the measuring system described above, doing so in an absolute fashion with high accuracy both in terms of location and in terms of angle.

In a known way, the components to be measured, in this case the upper frame structure 3, have corresponding reference collars (not illustrated) that can be appropriately scanned with the aid of one or more tactile measuring elements 30.

The novel measuring system, which is a combined measuring technique composed of tactile and optical systems, is distinguished by the common reference surface 26 for the two measuring systems, it being possible thereby for the measurement results of the two methods to be directly compared and combined with one another. In this way, it is no longer necessary, as in the prior art, for the measurements envisaged to alternate with the workpiece between two measuring sites, something which necessarily results in calibration errors.

A further advantage of the system is also time saved by the parallel operation of the two measuring systems and owing to the elimination of any time for transport and prepositioning between two measuring sites.

Systematic calibration errors can occur with use of the surface of the measuring table 21 as reference surface 26 for both measuring systems.

It is also advantageous to expand the measuring machine 20 as a mounting and adjusting station. Corrections at the component to be measured or the parts of the components can be undertaken on the measuring machine 20, and then the corresponding changes in location and angle of the relevant parts can be determined or measured without loss of the calibration and the referencing with reference to reference surfaces or reference points for the two measuring systems. The mounting and adjusting process, including the use of both measuring systems, can be performed iteratively, specifically without the need to recalibrate the measuring machine.

In order to install the refractive part, specifically the lens barrel 6, in the lower frame structure 4, the latter is mounted on the measuring table 21 with the reference surface 26. The refractive part 6 of the projection objective 1 to be assembled is inserted for this purpose into a bore in the lower frame structure 4, parts of the refractive part 6 extending into the measuring bore 22 (see FIG. 5).

The assembly of the projection objective 1, which has been installed with its parts in the upper frame structure 3 and in the lower frame structure 4 will be described below. It is assumed in this case that the positions and angles of the individual components are correspondingly exactly correct. A further basis or reference surface 32 is formed for this purpose on the top side of the lower frame structure 4. The reference surface 32 is thus located at the point at which the two frame structures 3 and 4 are assembled. The assembly can likewise be performed in this case on the measuring machine 20. As explained above, in this case the optical components in the upper frame structure 3 are referred to the reference surface 27 and, in terms of location, to the tip of the double mirror 28. In this way, the reference points of the two objective parts can be adjusted relative to one another with the required accuracy by mounting the upper frame structure 3 on the lower frame structure 4 and by displacing the upper frame structure 3. The tip of the double mirror 28 serves as reference point 33 for the components installed in the upper frame structure 3, and a reference point 34 at a main flange or centering collar 35 of the refractive part 6 serves for the refractive part 6, installed in the lower frame structure 4, of the projection objective 1.

As already mentioned the two frame structures 3 and 4 can consist of ceramic. The same also holds for the main flange or centering collar 35. The center or the reference point 34 of the centering collar 35 forms the center of the module. This center is determined with the aid of the tactile measuring elements 30 in conjunction with appropriate displacement of the measuring head 29 on the measuring table 21. As soon as the center of the module has been found in this way, the refractive part 6 previously inserted in the measuring bore 22 for the purpose of measurement is used to set the upper frame structure 3 in which the other objective parts had already been installed correctly as regards location and angle. The upper frame structure 3 is also mounted in this case on the lower frame structure 4.

For the purpose of accurate adjustment, the reference surface 27 of the upper frame structure 3 is displaced appropriately on the reference surface 32 of the lower frame structure 4 until the reference point 33 lies exactly at the precalculated location (opposite or) relative to the reference point 34.

It is important in the case of both components that the optical axes were referenced at right angles to the reference surfaces 26 and 27, so that displacement along the reference surface 32 is possible without loss of the referencing of the optical axis.

After the upper frame structure 3 is mounted on the lower frame structure 3 all that is still required is to align the two reference points 33 and 34 with one another. For this purpose, the upper frame structure 3 is displaced appropriately on the lower frame structure 4 until the tolerance range is reached.

It is decisive in this case to reference the reference surface 26 of the measuring table 21, whereby the upper frame structure 3 can be displaced on the reference surface 32 of the lower frame structure 4 without changing the preceding referencing and/or adjusting. In this case, a precondition therefore is also that the angles have been set in advance. The angles are no longer varied when displacing the location of the upper frame structure 3 on the lower frame structure 4 in order to set up the reference points 33 and 34 relative to one another. This means that the optical axes also are exactly correct.

Of course, it is also possible within the scope of the invention to subdivide into still more subgroups instead of assembling the projection objective 1 from two components, specifically the upper frame structure 3 and the lower frame structure 4.

Basically, three reference planes or reference surfaces are present, specifically the surface of the measuring table 21 as reference surface 26, the reference surface 27 on the underside of the upper frame structure 3 and the reference surface 32 on the top side of the lower frame structure 4. The reference surface 26 of the measuring table 21 serves in this case as base surface.

Whereas distances b₁ and b₂ are determined with the aid of the measuring machine 20, the angular positions are monitored and set with the aid of the optical measuring system via the autocollimation telescope 24.

Of course, the assembly can also be performed at another point instead of assembling the upper part and lower part of the projection objective 1 on the measuring table 21.

After exact adjustment of the two reference points 33 and 34 relative to one another, the two objective parts or the upper frame structure 3 are/is connected to the lower frame structure 4, whereby the projection objective 1 is assembled. The connection can be performed in any way desired, for example by threaded joints 36 in accordance with FIG. 1.

In order when joining the upper frame structure 3 to the lower frame structure 4 in accordance with FIG. 6 to be able to carry out with little friction a very exact displacement when making a displacement on the reference surface 32, an air cushion is produced between the two parts by means of air bearings 37. The air bearings 37 are depicted in FIG. 6 only in principle. It is also likewise possible to use fine adjustment elements, for example piezoceramic elements, electrodynamic drive elements or linear motors. It is possible in this way to displace the top part or the upper frame structure 3 with very little friction on the lower frame structure 4. Sensors and actuators, for example piezomanipulators, can then be used to adjust the upper frame structure 3 exactly. During mounting, the signal from the measuring element 30, which scans the tip of the double mirror 28 with the reference point 33, can be used as input signal for driving the piezomanipulators with the aid of computers.

A very exact adjustment and positioning of the projection objective 1 requires an extremely precise application of the outer surfaces of the basic structure 2, that is to say the upper frame structure 3 and the lower frame structure 4, in order to create exact interface surfaces for the subgroups' of the projection objective 1. Also involved here is the angle α between the outer surfaces and the flatness of the outer surfaces, in particular of the lower outer surface or reference surface 27 of the upper frame structure 3 and the lower surface of the frame structure 4, which forms the reference surface 32.

The outer surfaces of the frame structures 3 and 4 can be processed relatively easily to be very flat and with very small angular tolerances, for example, surface lapping/polishing, grinding or similar processing methods. The plane interference surfaces created in this way permit centering of the components, in particular adjustment of the upper frame structure 3 relative to the lower frame structure 4 by an appropriately exact displacement. An additional radial centering interface surface is generally no longer required.

During the mounting of the projection objective 1, it is also necessary for the mirror group 7′ to be positioned extremely accurately along the associated interface surface of the upper frame structure 3. This purpose is served by a lifting table 38 with the aid of piezoceramic elements that produce very sensitive changes in length of the lifting table 38 in conjunction with electrification. Lorentz motors or setting screws would likewise be possible as an alternative to the piezoceramic elements. The lifting table 38 is designed in this case such that activating piezoelements (not illustrated) renders it possible to move in the screwing-on plane of the mirror group 7′ on the outer surface or interface surface of the upper frame structure 3 in accordance with the direction of action illustrated by the arrow 39.

The interface surfaces are to be fabricated with particular accuracy, especially with reference to their flatness and their angular orientation. As a result of this, there is no longer any need to measure in two angles, and/or these angles no longer need to be set, since they are already fabricated.

The lifting table 38 can therefore be designed as a self-contained device relative to the measuring machine 20, and ensures appropriate alignment of the mirror group 7′.

1-22. (canceled)

23. A projection objective for imaging an object from a first plane into a second plane, having
(a) at least two lens barrels,
(b) refractive and reflective optical elements,
(c) a basic structure for bearing and holding the optical elements and the at least two lens barrels, and
(d) interface elements with the aid of which the lens barrels are connected to the basic structure.

24. The projection objective as claimed in claim 23, characterized in that the basic structure has at least two frame structures.

25. The projection objective as claimed in claim 23, characterized in that each of the lens barrels has an interface element.

26. The projection objective as claimed in claim 25, characterized in that at least one of the lens barrels has a flexible element in addition to the interface element.

27. The projection objective as claimed in claim 26, characterized in that the additional flexible element is designed as a diaphragm, the diaphragm being soft in an axial direction.

28. The projection objective as claimed in claim 25, characterized in that the interface element is designed as a thin-walled, closed, at least approximately tubular element.

29. The projection objective as claimed in claim 28, characterized in that the interface element is stiff in all degrees of freedom.

30. The projection objective as claimed in claim 23, characterized in that a multiplicity of flexures are provided for bearing the reflective optical elements.

31. The projection objective as claimed in claim 23, characterized in that the basic structure is formed from ceramic.

32. The projection objective as claimed in claim 31, characterized in that the basic structure is formed from a nonmetallic, ceramic material.

33. The projection objective as claimed in claim 32, characterized in that the basic structure is formed from silicon carbide (SiC).

34. The projection objective as claimed in claim 33, characterized in that the basic structure is formed from a reaction-bonded silicon-infiltrated silicon carbide (SiSiC).

35. The projection objective as claimed in claim 33, characterized in that the basic structure is formed from a sintered silicon carbide (SSiC).

36. The projection objective as claimed in claim 24, characterized in that the interface surfaces of at least two frame structures are formed by external surfaces.

37. The projection objective as claimed in claim 36, characterized in that the interface surfaces are processed by surface lapping, polishing or grinding to create a high angular accuracy and flatness.

38. The projection objective as claimed in claim 23, characterized in that at least one lens barrel has an approximately horizontal optical axis.

39. The projection objective as claimed in claim 23, characterized in that at least one lens barrel has a vertical optical axis.

40. The projection objective as claimed in claim 38, characterized in that a reflective element is arranged in the region, averted from a beam splitter element, of the lens barrel in an upper frame structure.

41. The projection objective as claimed in claim 40, characterized in that the at lest one lens barrel and the reflective element are arranged at an angle δ of up to 15° to a horizontal axis.

42. The projection objective as claimed in claim 24, characterized in that the lower frame structure is provided with a reference surface on which there is mounted an optical subsystem that is provided with at least one reference surface.

43. The projection objective as claimed in claim 42, characterized in that the reference surfaces of the subsystem form a reference point that can be adjusted relative to a reference point of the upper frame structure.

44. The projection objective as claimed in claim 43, characterized in that the reference point in the upper frame structure is formed by the tip of a double mirror.

45. The projection objective as claimed in claim 42, characterized in that the optical subsystem is designed as a refractive subsystem.

46. The projection objective as claimed in claim 42, characterized in that air bearings are provided for displacing the upper frame structure on the lower frame structure.

47. The projection objective as claimed in claim 42, characterized in that fine adjustment elements are provided for displacing the upper frame structure on the lower frame structure.

48. The projection objective as claimed in claim 47, characterized in that the fine adjustment elements are designed as piezoceramic elements, electrodynamic drive elements or linear motors.

49. A projection objective for imaging an object from a first plane into a second plane, having
(a) at lest two lens barrels,
(b) refractive and reflective optical elements,
(c) a basic structure for bearing and holding the optical elements and the at least two lens barrels, the basic structure having at least two frame structures, and
(d) interface elements with the aid of which the lens barrels are connected to the basic structure.

50. A projection objective for imaging an object from a first plane into a second plane, having
(a) at lest two lens barrels,
(b) refractive and reflective optical elements,
(c) a basic structure for bearing and holding the optical elements and the at least two lens barrels, the basic structure having at least two frame structures, and
(d) interface elements with the aid of which the lens barrels are connected to the basic structure, and
(e) flexures for bearing the reflective elements in one of at least two frame structures.
